(19) United States
(12) Patent Application Publication
(10) Pub. No.: US 2013/0154976 A1
(43) Pub. Date: Jun. 20, 2013

(54) TOUCH DEVICE AND TOUCH METHOD

(71) Applicant: ASUSTeK COMPUTER INC., Taipei (TW)

(72) Inventors: Hsiao-Kai LI, TAIPEI (TW); Wen-Chieh TSENG, TAIPEI (TW); Kuo-Chung CHIU, TAIPEI (TW); Sheng-Kai TANG, TAIPEI (TW)

(73) Assignee: ASUSTeK COMPUTER INC., TAIPEI (TW)

(21) Appl. No.: 13/714,377

(22) Filed: Dec. 13, 2012

(30) Foreign Application Priority Data
Dec. 20, 2011 (TW) 100147442

(51) Int. Cl. G06F 3/041

(52) U.S. Cl. CPC G06F 3/041
USPC 345/173

(57) ABSTRACT

A touch method and a touch device of a computer system are provided. The touch method comprises the steps outlined below.. A function control mode is performed. A graphic control frame comprising a first width having a default ratio relative to a second width of a touch pad of the touch device is displayed on a display device of the computer system. A touch input is received A displacement track and a position of the touch input are determined. At least one graphic control option on the graphic control frame is controlled according to the displacement track, the position of the touch input and the default ratio. The touch device used in the computer system is disclosed herein as ell.

### RELATED APPLICATIONS

This application claims priority to Taiwan Application Serial Number 100147442, filed Dec. 20, 2111, which is herein incorporated by reference.

### BACKGROUND

1. Technical Field

The present disclosure relates to touch input technology. More particularly, the present disclosure relates to a touch device and a touch method used in a computer system.

2. Description of Related Art

Computer plays an integral part in the daily life for most people because of its powerful ability of data processing and transmission. In order to communicate with the computer, input and output devices are indispensible and are provided to the user such that the user can interact with the computer. Common input devices include the mouse, keyboard and touch pad, in which the touch pad is a user-friendly input device since its operation mechanism is similar to the mouse. However, for a graphic control interface, it is not always intuitive to operate the interface with the touch pad. Besides, the width of the screen or the window is often far larger than that of the touch pad. If the user wants to operate a specific option on the graphic control interface, the user sometimes has to drag its finger for a long distance to reach the desired position, which is quite inconvenient.

### SUMMARY

An aspect of the present disclosure is to provide a touch device used in a computer system. The touch device comprises a touch pad, a determining module and a control module. The touch pad receives a touch input. The determining module determines a displacement track and a position of the touch input. The control module activates a function control mode to display a graphic control frame comprising a first width having a default ratio relative to a second width of the touch pad on a display device of the computer system. The control module further controls at least one graphic control option on the graphic control frame according to the displacement track of the touch input, the position of the touch input and the default ratio.

Another aspect of the present disclosure is to provide a touch method used in a touch device of a computer system. The touch method comprises the steps outlined below. A function control mode is performed. A graphic control frame comprising a first width having a default ratio relative to a second width of a touch pad of the touch device is displayed on a display device of the computer system. A touch input is received A displacement track and a position of the touch input are determined. At least one graphic control option on the graphic control frame is controlled according to the displacement track of the touch input, the position of the touch input and the specific ratio.

It is to be understood that both the foregoing general description and the following detailed description are by examples, and are intended to provide further explanation of the disclosure as claimed,

### BRIEF DESCRIPTION OF THE DRAWINGS

The disclosure can be more fully understood by reading the following detailed description of the embodiment, with reference made to the accompanying drawings as follows:

to FIG. 1 is a block diagram of a computer system in an embodiment of the present disclosure;

FIG. 2A is a top view of he computer system in an embodiment of the present disclosure;

FIG. 2B is a top view of the computer system under the function control mode in an embodiment of the present disclosure;

FIG. 3 is a top view of the computer system under the function control mode in another embodiment of the present disclosure;

FIG. 4A to FIG. 4C are top views of the computer system in an embodiment of the present disclosure; and

FIG. 5 is a flow chart of a touch method 500 in an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

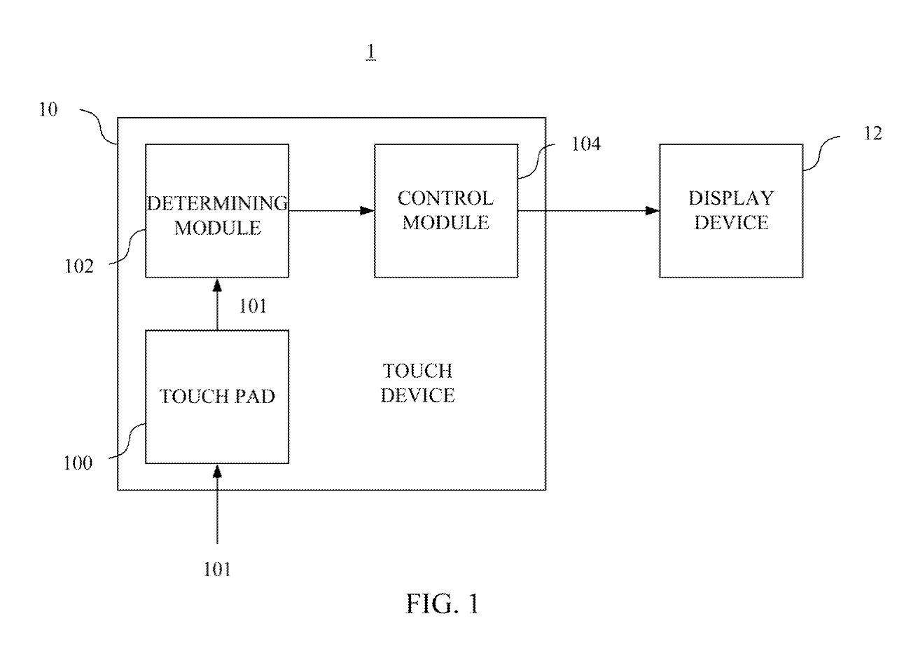

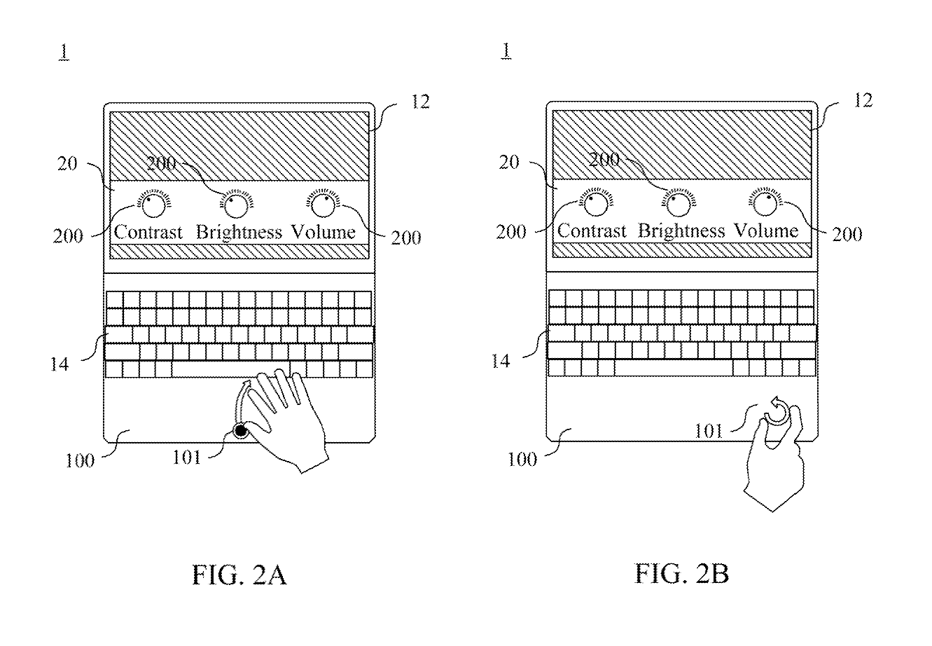

FIG. 1 is a block diagram of a computer system 1 in an embodiment of the present disclosure. FIG. 2A is a top view of the computer system 1 in an embodiment of the present disclosure. The computer system 1 comprises a touch device 10 and a display device 12.

The touch device 10 comprises a touch pad 100, a determining module 102 and a control module 104. The touch pad 100 receives a message of the movement of a touch input 101. In the present embodiment, the touch pad 100 can detect the external touch input 101. In the present embodiment, the touch pad 100 is disposed next to a keyboard 14 of the computer system 1 and the width of the touch pad 100 is similar to the width of the screen of the computer system 1.

The determining module 102 determines a displacement track and a position of the touch input 101. In different embodiments, the characteristic of the displacement track is selected from a group consisting of an initial position, a displacement amount, a shape or the combination of elements of the group. The position of the touch input 101 comprises the coordinates of the touch input 101 on the touch pad 100.

The control module 104 is able to operate the computer system 1 in a normal control mode and a function control mode. In different embodiments, the function control mode can be activated by the control module 104 according to a default gesture on the touch pad 100 or inputs from other input devices of the computer system (e.g. a default key or a default combination of keys on the keyboard 14). In an embodiment, the touch pad 100 under the normal control mode performs common touch pad functions such as the control of the cursor movement on a normal operation frame displayed on the display device 12. Hence, no further detail description of the normal control mode is discussed.

The function control mode is discussed herein by referencing FIG. 2A. When the function control mode is activated in the computer system 1, the control module displays a graphic control frame 20 comprising a first width having a default ratio relative to the width of the touch pad 100 (second width) on the display device 12 of the computer system 1. In the present embodiment, the default ratio between the first and the second width of the graphic control frame 20 and the touch pad 100 is 1:1, and the width of the graphic control frame 20 is similar to the width of the display device 12. In other embodiments, the width of the graphic control frame 20 can be smaller than the width of the display device 12 and the default ratio between the width of the graphic control frame 20 and the touch pad 100 can be adjusted in different applications. The user can control the computer system 1 more intuitively by using the touch pad 100 to directly control the displayed frame on the graphic control frame 20 according to the correspondence of the width and the length between the graphic control frame 20 and the touch pad 100. However, it is appreciated that the ratio of the width and the length between the width of the graphic control frame 20 and the touch pad 100 can be adjusted in different applications and is not limited in the embodiments of the present disclosure.

The graphic control frame 20 further comprises at least one graphic control option 200. In different embodiments, the graphic control option is selected from a group consisting of a knob, an adjusting bar, a scrolling bar, a page curl, other kinds of graphic control options or the combination of elements of the group. In the present embodiment, three graphic control options 200 are presented on the graphic control frame 20. Each of the three graphic control options 200 is a knob that respectively corresponds to the adjustment of the contrast of the display device 12, the brightness of the display device 12 and the volume of a speaker (not shown).

After the determining module 102 determines the displacement track and the position of the touch input 101, the control module 104 further controls the graphic control options 200 on the graphic control frame 20 according to the displacement track of the touch input 101, the position of the touch input 101 and the default ratio. For example, since the default ratio between the touch pad 100 and the graphic control frame 20 is 1:1, the control module 104 can control the graphic control options 200 by using an absolute coordinate system. In other words, the movement of the touch input along the x-axis of the touch pad 100 generated by the user directly corresponds to the action on the corresponding x-axis position on the graphic control frame 20 such that the user can operate the graphic control frame 20 more intuitively. Further, through the correspondence of the default ratio between the touch pad 100 and the graphic control frame 20 the user can directly and intuitively control the graphic control options 200 that correspond to the x-axis position of the graphic control frame 20 by generating the movement of the touch input along the x-axis of the touch pad 100 to further control the hardware or the software corresponding to the graphic control options 200 (e.g. the hardware or the software for adjusting the contrast of the display device 12, the brightness of the display device 12 and the volume of a speaker, etc).

As shown in the embodiment in FIG. 2A, the determining module 102 determines that the position of the touch input 101 applied on the touch pad 100 corresponds to the central part of the touch pad 100 and determines that the shape of the touch input 101 is an arc formed in a clockwise direction. Hence, the control module 104 can control the graphic control option 200 disposed at the central part of the graphic control frame 20, which is the knob for adjusting the brightness of the display device 12. The knob rotates clockwise according to the clockwise arc-shaped touch input 101 and the amount of the adjustment depends on the displacement amount of the touch input 101. Hence, the control mechanism described above is very intuitive.

FIG. 2B is a top view of the computer system 1 under the function control mode in an embodiment of the present disclosure. As shown in the embodiment in FIG. 2B, the determining module 102 determines that the position of the touch input 101 applied on the touch pad 100 corresponds to the right side of the touch pad 100 and determines that the shape of the touch input 101 is an arc formed in a counterclockwise direction. Since the default ratio between the graphic control frame 20 and the touch pad 100 is 1:1 the control module 104 can control the graphic control option 200 disposed at the right side of the graphic control frame 20, which is the knob for adjusting the volume of the system. The knob rotates counterclockwise according to the counterclockwise arc-shaped touch input 101 and the amount of the adjustment depends on the displacement amount of the touch input 101. Hence, the control mechanism described above is very intuitive.

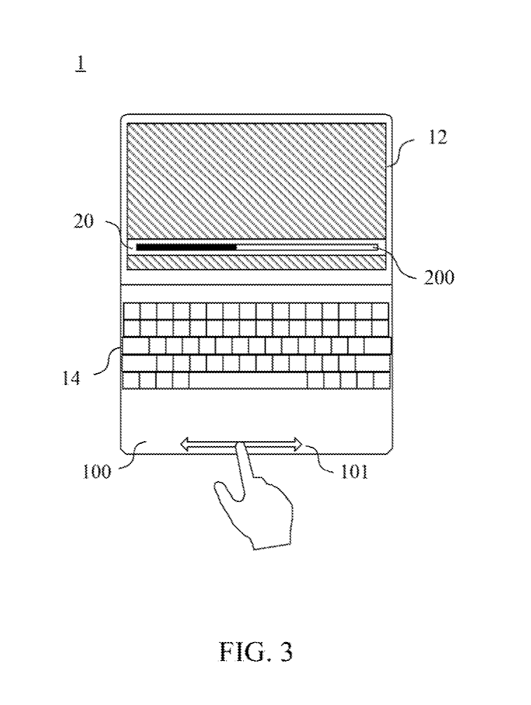

FIG. 3 is a top view of the computer system 1 under the function control mode in another embodiment of the present disclosure. In the present embodiment, the determining module 102 determines that the position of the touch input 101 applied on the touch pad 100 corresponds to the central part of the touch pad 100 and determines that the shape of the touch input 101 is a line traversing the touch pad 100. In the present embodiment, the graphic control option 200 is an adjusting bar, in which the graphic control frame 20 further displays the value of the parameters corresponding to the position of the adjusting bar such that the user can observe the adjusting process.

Since the default ratio between the graphic control frame 20 and the touch pad 100 is 1:1, the control module 104 can control the position of the adjusting bar according to the position of the touch input 101. When the shape of the touch input 101 is a Pine stretching along the right direction, the adjusting bar moves to the right side according to the touch input 101 and stops at the position corresponding to the end of the inputted line. The amount of the adjustment depends on the displacement amount of the touch input 101. Hence, the control mechanism described above is very intuitive.

In the embodiments discussed previously, the default ratio of 1:1 between the graphic control frame 20 and the touch pad 100 and the absolute coordinate are used merely as an example. In other embodiments, when the default ratio between the graphic control frame 20 and the touch pad 100 is not 11 (e.g. 2:1), a relative coordinate is used to operate the graphic control frame 20 in accordance to the touch pad. For example, when the default ratio is 2:1, a unit of the movement of the touch input 101 on the touch pad 100 will result in two units of the movement of the graphic control option 200 on the graphic control frame 20.

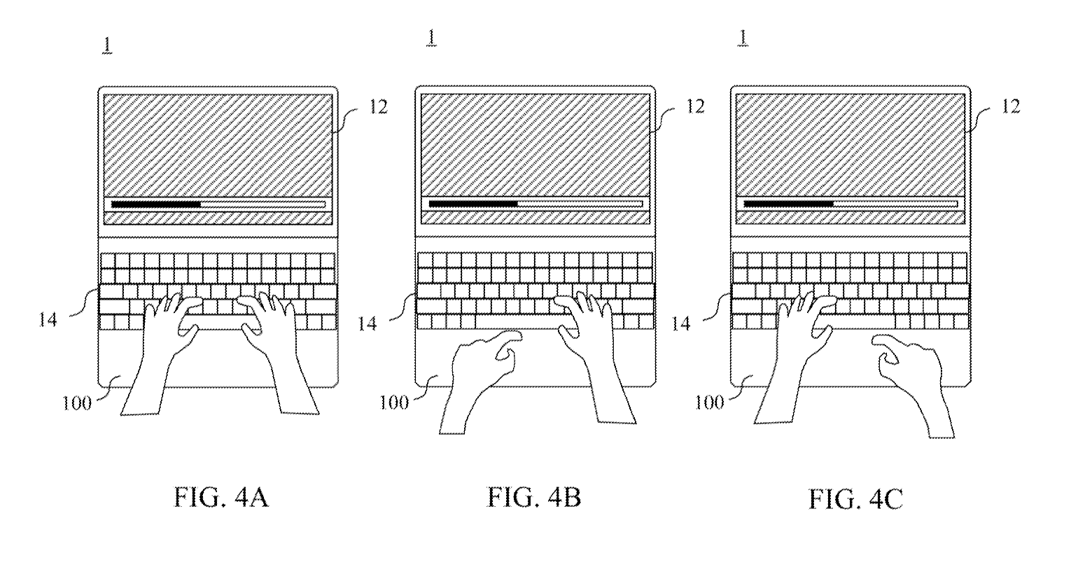

Each of FIG, 4A to FIG, 4C is a top view of he computer system 1 in an embodiment of the present disclosure. In the present embodiment, the determining module 102 can determine an area and a shape of the touch input 101 When the determining module 102 determines that the area of the touch input 101 is larger than a predetermined value or the shape of the touch input matches a predetermined pattern, the control module 104 does not perform any control action according to the touch input 101. For example, when the user uses both hands to operate the keyboard 14 and puts the arms on the touch pad 100, as shown in FIG. 4A, the determining module 102 detects a touch input 101 with large area and determines that the touch input 101 is not a correct input pattern. Hence, the control module 104 does not perform any control action according to the touch input 101. In FIG. 4B, when the user leans the left hand against the touch pad 100 and uses the right hand to perform the touch input, the determining module 102 detects that the palm of the left hand of the user matches a predetermined pattern and determines that the touch input 101 is not a correct input pattern. On the other hand, the determining module 102 determines that neither the area of the touch input generated by the right hand is larger than the predetermined value nor the shape of the touch input matches any predetermined pattern. Hence, the control module 104 generates the control command according to the touch input from the right hand of the user. The embodiment depicted in FIG, 4C is similar to the embodiment depicted in FIG. 4B while the incorrect touch input in FIG. 4C is generated from the palm of the right hand of the user leaning on the touch pad 100 and the correct touch input in FIG. 4C is generated from the left hand of the user. Thus, no more detail of the embodiment in FIG. 4C is discussed here.

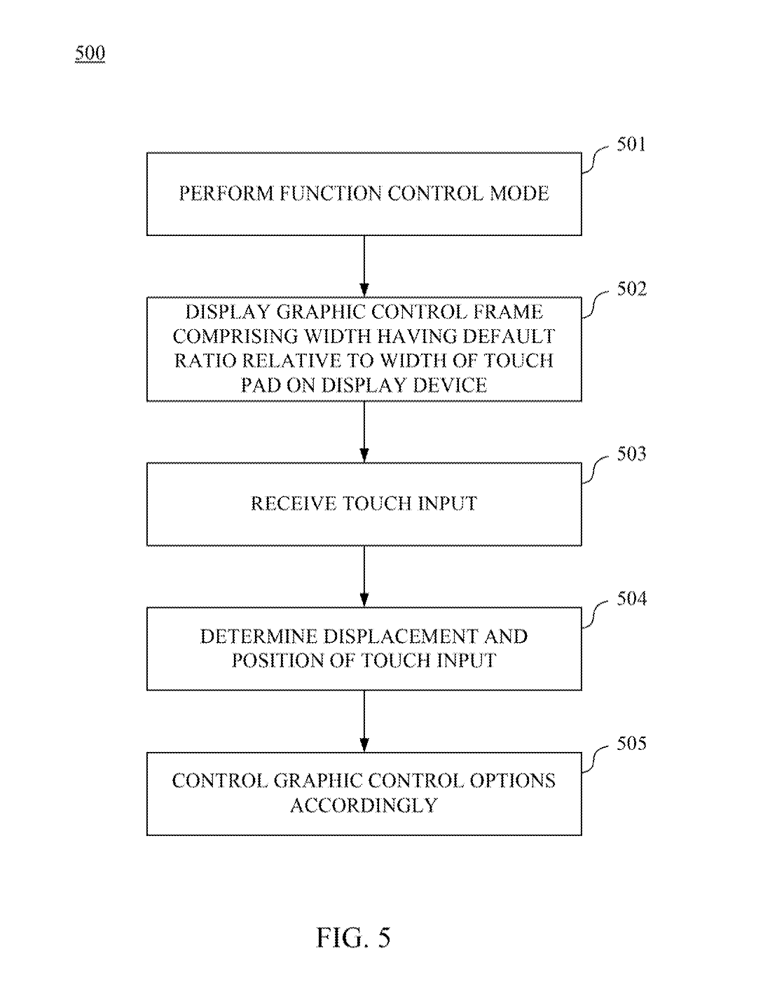

FIG. 5 is a flow chart of a touch method 500 in an embodiment of the present disclosure. The touch method 500 can be used in the touch device 100 of the computer system 1 depicted in FIG. 1. The touch method 500 comprises the steps outlined below.

In step 501, the control module 104 performs a function control mode.

In step 502, the control module 104 makes the display device 12 displays the graphic control frame 20 comprising the width having the default ratio relative to the width of the touch pad 100 of the touch device 10.

In step 503, the touch pad 100 receives the touch input 101.

In step 504, the determining module 102 determines the displacement track and the position of the touch input 101.

In step 505, the control module 104 controls the graphic control options 200 on the graphic control frame 20 according to the displacement track of the touch input 101, the position of the touch input 101 and the specific ratio.

The control mechanism of the touch device and the touch method of the present disclosure can be more intuitive due to the design of the function control mode and the width of the graphic control frame and the touch pad.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A touch device used in a computer system, wherein the touch device comprises:
a touch pad to receive a touch input;
a determining module to determine a displacement track and a position of the touch input; and
a control module to activate a function control mode to display a graphic control frame comprising a first width having a default ratio relative to a second width of the touch pad on a display device of the computer system;
wherein the control module further controls at least one graphic control option on the graphic control frame according to the displacement track of the touch input, the position of the touch input and the default ratio.

2. The touch device of claim 1, wherein the default ratio between the first and the second width of the graphic control frame and the touch pad is 1:1.

3. The touch device of claim 1, wherein the control module controls the at least one graphic control option by using an absolute coordinate system.

4. The touch device of claim 1, wherein a characteristic of the displacement track is selected from a group consisting of an initial position, a displacement amount, a shape or the combination of elements of the group.

5. The touch device of claim 1, wherein the graphic control option is selected from a group consisting of a knob, an adjusting bar, a scrolling bar, a page curl or the combination of elements of the group.

6. The touch device of claim 1, wherein the control module further determines an area and a shape of the touch input.

7. The touch device of claim 6, wherein the control module does not perform any controlling process according to the touch input when the area of the touch input is larger than a predetermined value or when the shape of the touch input matches a predetermined pattern.

8. A touch method used in a touch device of a computer system, wherein the touch method comprises:
performing a function control mode;
displaying a graphic control frame comprising a first width having a default ratio relative to a second width of a touch pad of the touch device on a display device of the computer system;
receiving a touch input;
determining a displacement track and a position of the touch input; and
controlling at least one graphic control option on the graphic control frame according to the displacement track of the touch input, the position of the touch input and the specific ratio.

9. The touch method of claim 8, wherein a characteristic of the displacement track is selected from a group consisting of an initial position, a displacement amount, a shape or the combination of elements of the group.

10. The touch method of claim 8, wherein the default ratio between the first and the second width of the graphic control frame and the touch pad is 1:1.

11. The touch method of claim 8, wherein the at least one graphic control option is controlled by using an absolute coordinate system.

12. The touch method of claim 8, wherein the graphic control option is selected from a group consisting of a knob, an adjusting bar, a scrolling bar, a page curl or the combination of elements of the group.

13. The touch method of claim 8, further comprising a step of determining an area and a shape of the touch input.

14. The touch method of claim 13, wherein none of controlling process is performed according to the touch input when the area of the touch input is larger than a predetermined value or when the shape of the touch input matches a predetermined pattern.
